(19) United States
(12) Patent Application Publication
(10) Pub. No.: US 2016/0186442 A1
(43) Pub. Date: Jun. 30, 2016

(54) LOW-COST AND ENVIRONMENT-FRIENDLY DECORATIVE BUILDING MATERIAL AND MANUFACTURING METHOD THEREOF

(71) Applicant: Shih-Chang Chang, Zhoug-Li (TW)

(72) Inventor: Shih-Chang Chang, Zhoug-Li (TW)

(73) Assignee: Printing Technology Research Institute, New Taipei City (TW)

(21) Appl. No.: 14/586,972

(22) Filed: Dec. 31, 2014

(51) Int. Cl. E04F 13/14; C04B 41/45; C09D 133/14; C04B 41/83; C04B 41/89; C04B 41/00; C04B 41/52

(52) U.S. Cl. CPC E04F 13/147; E04F 13/142; C04B 41/009; C04B 41/4539; C04B 41/455; C04B 41/4543; C04B 41/52; C04B 41/83; C04B 41/89; C09D 133/14; C04B 2111/542

(57) ABSTRACT

The present invention provides a low-cost and environment-friendly decorative building material and its manufacturing method to obtain a stone-like surface without actually using natural stones. Said low-cost and environment-friendly decorative building material comprises a substrate; multiple decorative colloids of various shapes and sizes distributed on and adhered to the top surface of the substrate; solidified base layers distributed respectively in correspondence with the decorative colloids, and located on the top surface of the decorative colloids to shape the decorative colloids after primary sintering; and protective layers of various colors and patterns, distributed respectively in correspondence with the decorative colloids, configured on the surface of the solidified base layer through spray printing, to shape and color the decorative colloids after secondary sintering; said solidified base layers and said protective layers both contain glaze powder; and said protective layers further contain glue that can fix the aforementioned glaze powder on the surface of the solidified base layers.

### BACKGROUND OF INVENTION

1. Field of the Invention

The present invention relates generally to a decorative building material and its manufacturing method.

2. Description of Related Art

In early days, flooring materials mostly come from natural stone or ceramic products. These materials are costly and may cause destruction of the natural environment. As a substitute, manufacturers gradually developed flooring tiles made of plastic materials, namely PVC floor tiles.

Over the recent years, along with the rapid change of the economic society, the demands of consumers become higher and higher, but meanwhile they are innately influenced by the natural environment, and value designs in connection with the nature. To cater to the new demands of consumers, companies in the building industry are once again beginning to invest in the market of natural stone building materials.

In the market of natural stone building materials like cobblestone tiles, massive amount of stone materials shall be prepared before production. This causes considerable destruction to the natural environment. Meanwhile, it takes a long time to prepare the stone materials, and the manufacturers need to pay attention that the stones must meet specific application criterions, such as sizes, colors, surface conditions etc. The manufacturing process is also time-consuming and costly. Therefore, the final price of the stone building materials is staying at a high level.

In view of the aforementioned problems, the present invention aims to make some improvements to reduce the cost, price and manufacturing difficulty by providing a low-cost and environment-friendly decorative building material and its manufacturing method characterized by easy production and non-use of natural stones.

### SUMMARY OF THE INVENTION

The present invention overcomes the aforementioned problems from two aspects. Firstly, in the aspect of building materials, it is a low-cost and environment-friendly decorative building material (100), comprising a substrate (1); multiple decorative colloids (2) of various shapes and sizes distributed on and adhered to the top surface of the substrate (1); solidified base layers (3) distributed respectively in correspondence with the decorative colloids (2), and located on the top surface of the decorative colloids (2) to shape the decorative colloids (2) after primary sintering; and protective layers (4) of various colors and patterns, distributed respectively in correspondence with the decorative colloids (2), configured on the surface of the solidified base layer (3) through spray printing, to shape and color the decorative colloids (2) after secondary sintering; said solidified base layers (3) and protective layers (4) both contain glaze powder (5); while said protective layers (4) further contain glue (6) that can fix the aforementioned glaze powder (5) on the surface of the solidified base layers (3).

Secondly, in the aspect of manufacturing method, there are the following steps: Step 1 (I): A substrate (1) is obtained; Step 2 (II): Decorative colloids (2) of various shapes and sizes are distributed on and adhered to the top surface of the substrate (1) to form a rough blank (A); Step 3 (III): Inside a sealed space, glaze powder (5) is sprayed on the top surface of the rough blank (A); Step 4 (IV): After spraying the glaze powder (5), the top surface of the rough blank (A) is blown to remove and recycle the glaze powder (5) not falling on the top surface of the decorative colloids (2), and now a rough semi-finished product (B) is formed; Step 5 (V): The rough semi-finished product (B) undergoes a primary sintering, and after the sintering, a solidified base layer (3) is formed on the top surface of each decorative colloid (2), and now a refined semi-finished product (C) is formed; Step 6 (VI): Inside a sealed space, a spray printing machine is used to spray the aforementioned refined semi-finished product (C) to add a protective layer (4) on each of the decorative colloids (2), and now a semi-finished product (D) is formed; and Step 7 (VII): Wait for the protective layer (4) to dry; when the protective layer (4) becomes dry, the semi-finished product (D) undergoes a secondary sintering; and after the secondary sintering, a low-cost and environment-friendly decorative building material (100) is now finished.

Comparing to the existing techniques, the present invention has the following efficacies:

Through a combination of decorative colloid (2), solidified base layer (3), and protective layer (4), the present invention realizes its goal to reduce the cost, price and manufacturing difficulty. The coloring method using spray printing can simplify the overall processes and meet diversified and customized application needs of consumers. The present invention can perfectly imitate stone decorative building materials to minimize destruction of the environment and substantially enhance industrial applicability.

Apart from its flexible applications to meet diversified consumer needs, the manufacturing method of the present invention further produces a unique low-cost and environment-friendly decorative building material. More importantly, it reduces manufacturing cost and time to enable fast applications by the consumers.

As the present invention forms a protective layer (4) through spray printing, it can satisfy more diversified application needs of the consumers.

### BRIEF DESCRIPTION OF THE DRAWINGS

FIG. 1: a perspective view of the present invention.

FIG. 2: a partial sectional view of FIG. 1.

FIG. 3: a manufacturing process block diagram of the present invention.

FIG. 4 and FIG. 5: schematic flow diagrams of the manufacturing process of the present invention.

### DETAILED DESCRIPTION OF THE INVENTION

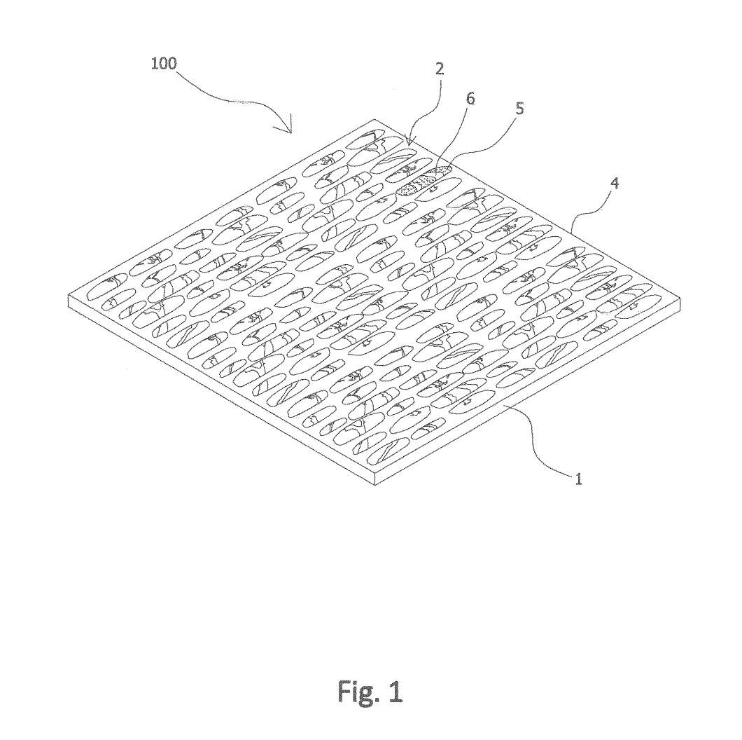

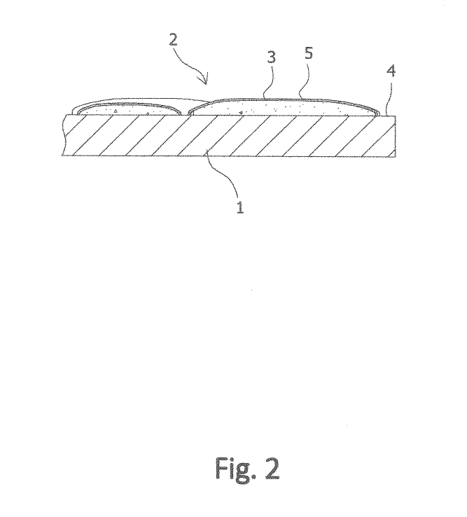

FIGS. 1, and 2 disclose a low-cost and environment-friendly decorative building material, wherein: said low-cost and environment-friendly decorative building material (100) comprises: a substrate (1); multiple decorative colloids (2) of various shapes and sizes distributed on and adhered to the top surface of the substrate (1); solidified base layers (3) distributed respectively in correspondence with the decorative colloids (2), and located on the top surface of the decorative colloids (2) to shape the decorative colloids (2) after primary sintering; and protective layers (4) of various colors and patterns, distributed respectively in correspondence with the decorative colloids (2), configured on the surface of the solidified base layer (3) through spray printing, to shape and color the decorative colloids (2) after secondary sintering; said solidified base layers (3) and said protective layers (4) both contain glaze powder (5); while said protective layers (4) further contain glue (6) that can fix the aforementioned glaze powder (5) on the surface of the solidified base layers (3).

The aforementioned combination of decorative colloid (2), solidified base layer (3), and protective layer (4) can reduce the cost, price and manufacturing difficulty of the low-cost and environment-friendly decorative building material (100) and can obtain the texture and sense of quality of natural stones without actually using natural stones.

Secondly, based on the combination of glaze powder (5) and glue (6), the spray printing method can simplify the overall manufacturing processes of low-cost and environment-friendly decorative building material (100), and can realize customization, fast production, as well as easy control to reduce the reject ratio.

The combined maximum thickness of the solidified base layers (3) and the protective layers (4) is 6 mm. Various options of the thickness of the solidified base layer (3) and protective layer (4) can be freely selected by consumers to meet their specific needs for safety and comfort.

The aforementioned substrate (1) is one of the followings: ceramic plate and ceramic tile. When said substrate (1) is a ceramic plate, its thickness range is 3 mm˜6 mm; while when said substrate (1) is a ceramic tile, its thickness range is 5 mm˜10 mm. To meet diversified consumer needs and applications, the substrate (1) can be of various materials and various thicknesses. Therefore, the present invention can have a wider application range, with no problem of inapplicability.

The aforementioned decorative colloid (2) contains isobornyl acrylate, 1,6-hexanediol diacrylate, tetrahydrofurfuryl acrylate, multifunctional acrylate, 2-hydroxy-2-methylpropiophenone, diphenyl (2,4,6-trimethylbenzoyl) phosphine oxide, and additive.

The weight percentage of the aforementioned isobornyl acrylate is 5˜15; the weight percentage of the aforementioned 1,6-hexanediol diacrylate is 10˜20; the weight percentage of said tetrahydrofurfuryl acrylate is 20˜30; the weight percentage of the aforementioned multifunctional acrylat is 20˜30; the weight percentage of the aforementioned 2-hydroxy-2-methylpropiophenone is 1˜5; the weight percentage of the aforementioned diphenyl (2,4,6-trimethylbenzoyl) phosphine oxide is 1˜10; and the weight percentage of the aforementioned additive is 1˜10.

Through adoption of the aforementioned decorative colloid (2), the present invention can perfectly imitate stones, with sufficient hardness and good resistance to repeated high-temperature heating. Moreover, it will not fall easily apart from the top surface of the substrate (1).

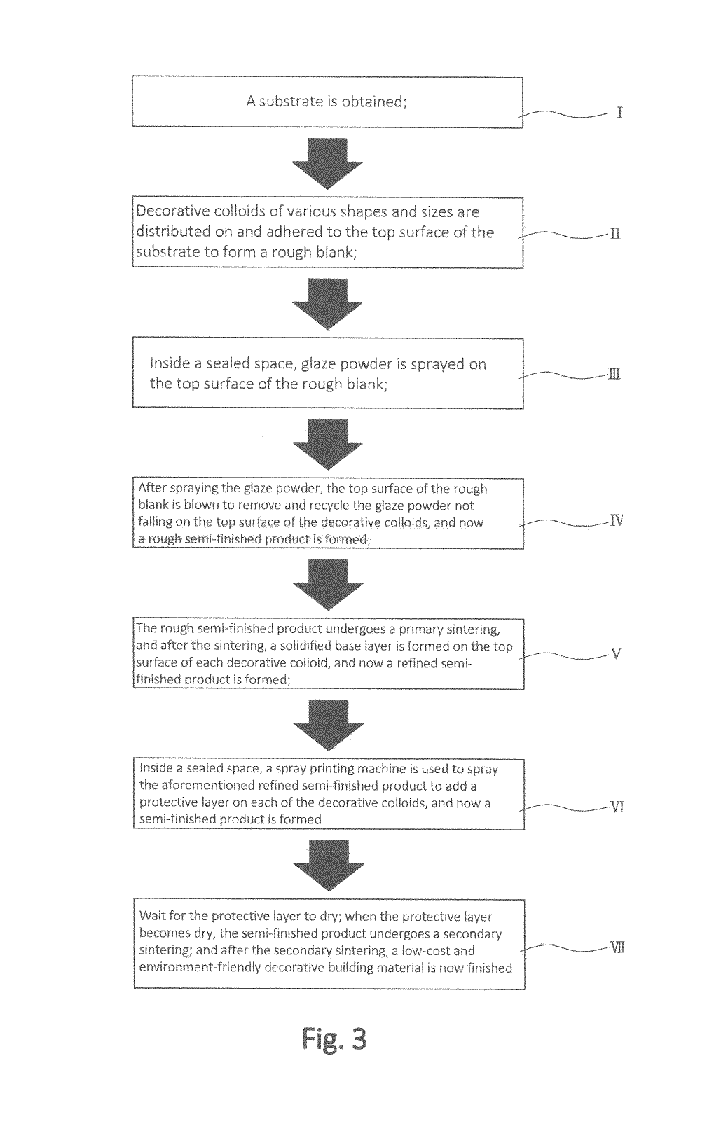

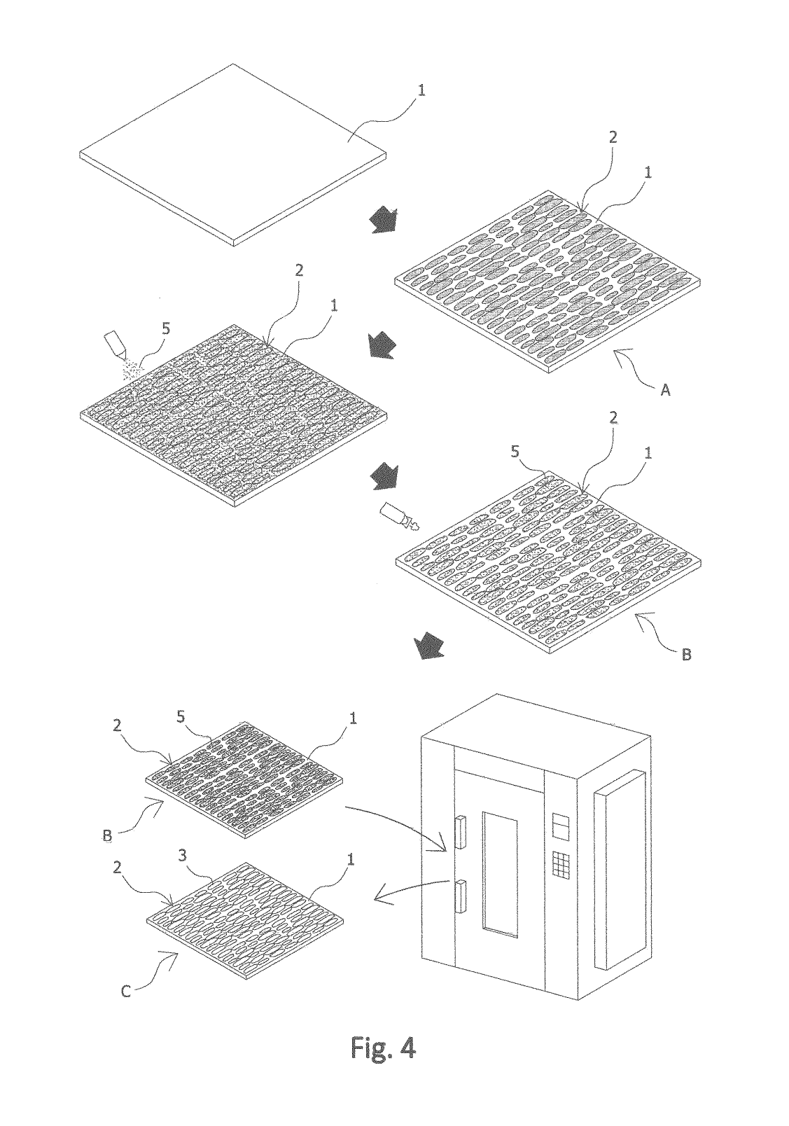

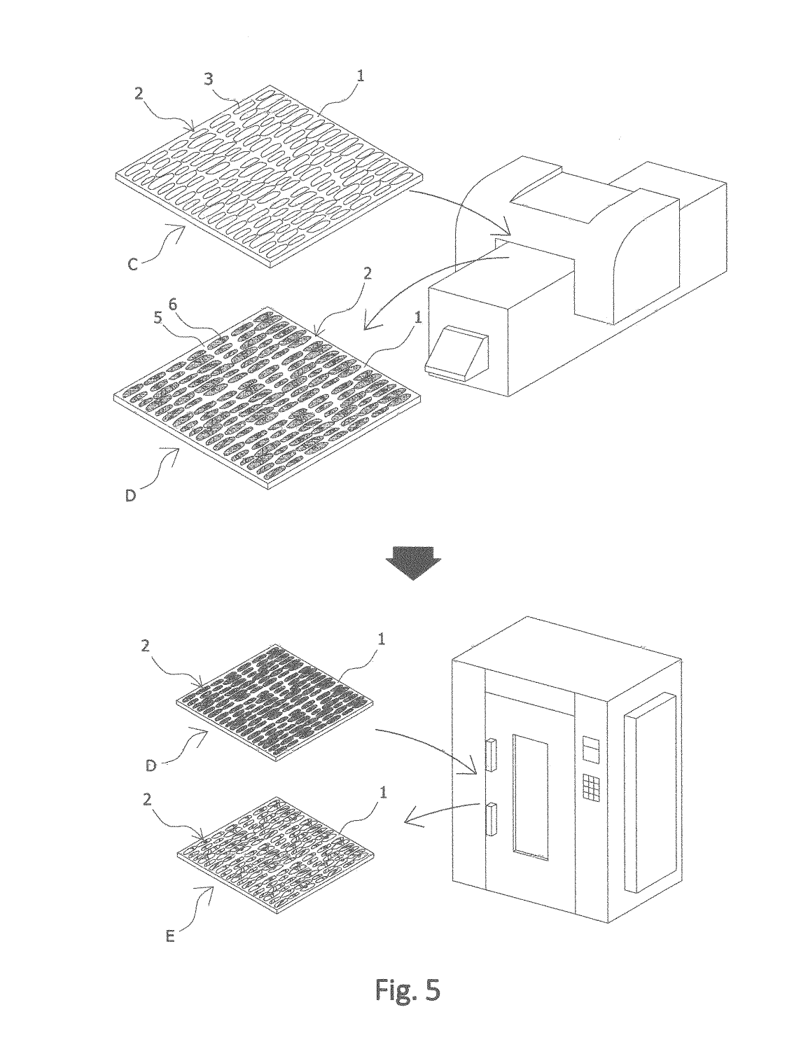

FIG. 3˜5 disclose the manufacturing method of the low-cost and environment-friendly decorative building material, including: Step 1 (I): a substrate (1) is obtained; Step 2 (II): Decorative colloids (2) of various shapes and sizes are distributed on and adhered to the top surface of the substrate (1) to form a rough blank A; Step 3 (III): Inside a sealed space, glaze powder (5) is sprayed on the top surface of the rough blank A; Step 4 (IV): After spraying the glaze powder (5), the top surface of the rough blank A is blown to remove and recycle the glaze powder (5) not falling on the top surface of the decorative colloids (2), and now a rough semi-finished product B is formed; Step 5 (V): The rough semi-finished product B undergoes a primary sintering, and after the sintering, a solidified base layer (3) is formed on the top surface of each decorative colloid (2), and now a refined semi-finished product C is formed; Step 6 (VI): Inside a sealed space, a spray printing machine is used to spray the aforementioned refined semi-finished product C, to add a protective layer (4) on each of the decorative colloids (2), and now a semi-finished product D is formed; and Step 7 (VII): Wait for the protective layer (4) to dry; when the protective layer (4) becomes dry, the semi-finished product D undergoes a secondary sintering; and after the secondary sintering, a low-cost and environment-friendly decorative building material (100) is now finished.

Through implementation of this manufacturing method, the production becomes very flexible. Comparing to traditional stone decorative plates, as there is no longer a need to select and look for specific stones, the cost of material preparation is very low, the labor hour and manpower are dramatically reduced, and more time and resources can be saved. All these will contribute to lowered price and easy popularization of the low-cost and environment-friendly decorative building material (100).

Secondly, during the whole manufacturing process, the reject ratio can be reduced. Even though some rejects are generated, they can still be recycled and reproduced before sintering. As a result, the production cost becomes lower, and the reject ratio is effectively reduced.

Furthermore, through the combination of decorative colloids (2) and solidified base layers (3), large amounts of spare materials can be produced and maintained at Step 5 (V). When there is a need, the subsequent processing steps can be carried out. This is beneficial for product control.

As stated above, said Step 6 (VI) further includes an action simultaneous to the spray printing to collect the dispersed glaze powder (5).

Moreover, this action can minimize the pollution caused by dispersal of the glaze powder (5), and meanwhile avoid re-deposition on the substrate (1) to make the protective layer (4) dirty and cause rejects.

The temperature range of the aforementioned primary sintering and secondary sintering is 1000° C.˜1140° C. Particularly, based on specific sintering needs of the solidified base layer (3) and the protective layer (4), after sintering under corresponding sintering temperatures, perfect shaping, appearance and protective effects can be achieved.

Said Step 7 (VII) further includes a metal sandblast processing of the top surface of the finished product E, so that the protective layer (4) and the top surface of the substrate (1) can have a coarse texture. After the metal sandblast processing, the low-cost and environment-friendly decorative building material (100) can have different styles like smooth, coarse etc. In this way, the application range of the present invention can be expanded.

To conclude, through the combination of decorative colloids (2), solidified base layers (3), and protective layers (4), plus the spray printing and glaze sintering methods, the present invention simplifies the overall manufacturing processes, and provides consumers with a nice, low-cost and environment-friendly decorative building material (100), perfectly satisfying the diversified application needs of the consumers. It not only reduces the manufacturing cost, but also reduces the time of production. Comparing to traditional decorative building materials, it has better usability, practicability, efficacies and industrial applicability.

We claim:

1. A low-cost and environment-friendly decorative building material, said low-cost and environment-friendly decorative building material (100) comprising:
a substrate (1);
a plurality of decorative colloids (2) of various shapes and sizes distributed on and adhered to a top surface of the substrate (1);
solidified base layers (3) distributed respectively in correspondence with the decorative colloids (2), and disposed on a top surface of the decorative colloids (2) to shape the decorative colloids (2) after primary sintering; and
protective layers (4) of various colors and patterns, distributed respectively in correspondence with the decorative colloids (2), configured on a surface of the solidified base layer (3) through spray printing, to shape and color the decorative colloids (2) after secondary sintering;
said solidified base layers (3) and said protective layers (4) both containing glaze powder (5);
and said protective layers (4) further containing glue (6) that can fix the glaze powder (5) on the surface of the solidified base layers (3).

2. The structure defined in claim 1, wherein the combined maximum thickness of said solidified base layers (3) and protective layers (4) is 6 mm.

3. The structure defined in claim 1, wherein said substrate (1) is one of the followings: ceramic plates and ceramic tiles.

4. The structure defined in claim 3, wherein said substrate (1) is a ceramic plate, whereof the thickness range is 3 mm˜6 mm; while said substrate (1) is a ceramic tile, whereof the thickness range is 5 mm˜10 mm.

5. The structure defined in claim 1, wherein said decorative colloid (2) contains isobornyl acrylate, 1,6-hexanediol diacrylate, tetrahydrofurfuryl acrylate, multifunctional acrylate, 2-hydroxy-2-methylpropiophenone, diphenyl (2,4,6-trimethylbenzoyl) phosphine oxide, and additive.

6. The structure defined in claim 5, wherein the weight percentage of said isobornyl acrylate is 5˜15;
the weight percentage of 1,6-hexanediol diacrylate is 10˜20;
the weight percentage of tetrahydrofurfuryl acrylate is 20˜30;
the weight percentage of multifunctional acrylate is 20˜30;
the weight percentage of 2-hydroxy-2-methylpropiophenone is 1˜5;
the weight percentage of diphenyl (2,4,6-trimethylbenzoyl) phosphine oxide is 1˜10;
the weight percentage of additive is 1˜10.

7. The method defined in claim 1, which comprises the following steps:
step 1 (I): A substrate (1) is obtained;
step 2 (II): Decorative colloids (2) of various shapes and sizes are distributed on and adhered to the top surface of the substrate (1) to form a rough blank (A);
step 3 (III): Inside a sealed space, glaze powder (5) is sprayed on the top surface of the rough blank (A);
step 4 (IV): After spraying the glaze powder (5), the top surface of the rough blank (A) is blown to remove and recycle the glaze powder (5) not falling on the top surface of the decorative colloids (2), and now a rough semi-finished product (B) is formed;
step 5 (V): The rough semi-finished product (B) undergoes a primary sintering, and after the sintering, a solidified base layer (3) is formed on the top surface of each decorative colloid (2), and now a refined semi-finished product (C) is formed;
step 6 (VI): Inside a sealed space, a spray printing machine is used to spray the aforementioned refined semi-finished product (C) to add a protective layer (4) on each of the decorative colloids (2), and now a semi-finished product (D) is formed; and
step 7 (VII): Wait for the protective layer (4) to dry; when the protective layer (4) becomes dry, the semi-finished product (D) undergoes a secondary sintering; and after the secondary sintering, a low-cost and environment-friendly decorative building material (100) is now finished.

8. The method defined in claim 7, wherein said Step 6 (VI) further includes an action simultaneous to the spray printing to collect the dispersed glaze powder (5).

9. The method defined in claim 7, wherein the temperature range of said primary sintering and secondary sintering is 1000° C.˜1140° C.

10. The method defined in claim 7, wherein said Step 7 (VII) further includes a metal sandblast processing of the top surface of the finished product (E), so that the protective layer (4) and the top surface of the substrate (1) can have a coarse texture.
